(19) United States
(12) Patent Application Publication
(10) Pub. No.: US 2022/0164839 A1
(43) Pub. Date: May 26, 2022

(54) APPLICATION PROGRAMMING INTERFACE FOR EXCHANGING USED ITEMS IN AN ONLINE MARKETPLACE

(71) Applicants: Kristy Leilani Caylor, Ojai, CA (US); Mary McCain Saunders Symonds, Lawndale, CA (US)

(72) Inventors: Kristy Leilani Caylor, Ojai, CA (US); Mary McCain Saunders Symonds, Lawndale, CA (US)

(21) Appl. No.: 17/534,760

(22) Filed: Nov. 24, 2021

Related U.S. Application Data
(60) Provisional application No. 63/117,745, filed on Nov. 24, 2020.

(51) Int. Cl. G06Q 30/06; G06F 16/28; G06F 16/23

(52) U.S. Cl. CPC G06Q 30/0601; G06F 16/2365; G06F 16/28

(57) ABSTRACT

This disclosure is directed to an application programming interface for exchanging items in an ecommerce marketplace. A server receives an indication of a first transaction, at a first time, to purchase a first set of items by a user account. The server stores a purchased indication for each of the one or more items in the first set in a purchase history database for the user account. The server receives an indication of a process initiating for a second transaction, the second transaction occurring at a second time later than the first time. The server receives, as part of the process for the second transaction, a request to exchange a first item of the first set of items. The server calculates an exchange price for the first item. The server applies a credit to the user account, wherein the credit is equal to the exchange price.

### PRIORITY INFORMATION

This application claims priority to U.S. Provisional Patent Application No. 63/117,745, filed Nov. 24, 2020, the entire contents of which are incorporated herein.

### TECHNICAL FIELD

The disclosure relates to ecommerce transacting methods.

### BACKGROUND

In many industries, including the clothing industry, there is a tremendous waste issue. In these linear economy models, companies are incentivized to sell more and more items rather than reuse the products that are already made. There are upwards of 21 billion pounds of clothing going to landfills. Even in donation and thrift stores, 85% of donations eventually go into landfills. This linear economy, rather than a circular model that focuses on recycling and upcycling, produces many harmful environmental effects. There is a need to have recycled and upcycled clothing items, making new products out of those old clothes. Currently, the resale market is reserved for lightly used clothes, and there are typically not enough benefits to utilize this process.

### SUMMARY

In general, the disclosure describes an exchange system, which may include an artificial intelligence model, to determine an amount of credit to apply to a user account during an ecommerce transaction. One or more processors receive an indication of a first transaction to purchase a first set of one or more items by a user account, the first transaction occurring at a first time. The one or more processors further store a purchased indication for each of the one or more items in the first set in a purchase history database for the user account. The one or more processors also receive an indication of a process initiating for a second transaction, the second transaction occurring at a second time later than the first time. The one or more processors further receive, as part of the process for the second transaction, a request to exchange a first item of the first set of one or more items. The one or more processors also calculate an exchange price for the first item. The one or more processors further apply a credit to the user account, wherein the credit is equal to the exchange price.

In one example, the disclosure is directed to a method comprising receiving, by one or more processors of a server device, an indication of a first transaction to purchase a first set of one or more items by a user account, the first transaction occurring at a first time. The method further comprises storing, by the one or more processors of the server device, a purchased indication for each of the one or more items in the first set in a purchase history database for the user account. The method also comprises receiving, by the one or more processors of the server device, an indication of a process initiating for a second transaction, the second transaction occurring at a second time later than the first time. The method further comprises receiving, by the one or more processors of the server device and as part of the process for the second purchase, a request to exchange a first item of the first set of one or more items. The method further comprises calculating, by the one or more processors of the server device, an exchange price for the first item. The method also comprises applying, by the one or more processors of the server device, a credit to the user account, wherein the credit is equal to the exchange price.

In another example, the disclosure is directed to a device comprising one or more communication units. The device further comprises one or more storage components configured to store a purchase history database. The device also comprises one or more processors configured to receive an indication of a first transaction to purchase a first set of one or more items by a user account, the first transaction occurring at a first time. The one or more processors are further configured to store a purchased indication for each of the one or more items in the first set in the purchase history database for the user account. The one or more processors are also configured to receive an indication of a process initiating for a second transaction, the second transaction occurring at a second time later than the first time. The one or more processors are further configured to receive, as part of the process for the second purchase, a request to exchange a first item of the first set of one or more items. The one or more processors are also configured to calculate an exchange price for the first item. The one or more processors are further configured to apply a credit to the user account, wherein the credit is equal to the exchange price.

In another example, the disclosure is directed to a non-transitory computer-readable storage medium having stored thereon instructions that, when executed, cause one or more processors of a server device to receive an indication of a first transaction to purchase a first set of one or more items by a user account, the first transaction occurring at a first time. The instructions, when executed, further cause the one or more processors to store a purchased indication for each of the one or more items in the first set in a purchase history database for the user account. The instructions, when executed, also cause the one or more processors to receive an indication of a process initiating for a second transaction, the second transaction occurring at a second time later than the first time. The instructions, when executed, further cause the one or more processors to receive, as part of the process for the second purchase, a request to exchange a first item of the first set of one or more items. The instructions, when executed, also cause the one or more processors to calculate an exchange price for the first item. The instructions, when executed, further cause the one or more processors to apply a credit to the user account, wherein the credit is equal to the exchange price.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram illustrating an example environment that includes a server device configured to perform the techniques described herein.

FIG. 2 is a block diagram illustrating a more detailed example of a server device configured to perform the techniques described herein.

FIG. 3 is a conceptual diagram illustrating an example graphical user interface in accordance with one or more of the techniques described herein.

FIG. 4 is a conceptual diagram illustrating an example graphical user interface in accordance with one or more of the techniques described herein.

FIG. 5 is a conceptual diagram illustrating an example graphical user interface (GUI) in accordance with one or more of the techniques described herein.

FIG. 6 is a flow diagram illustrating an example technique of the current disclosure.

### DETAILED DESCRIPTION

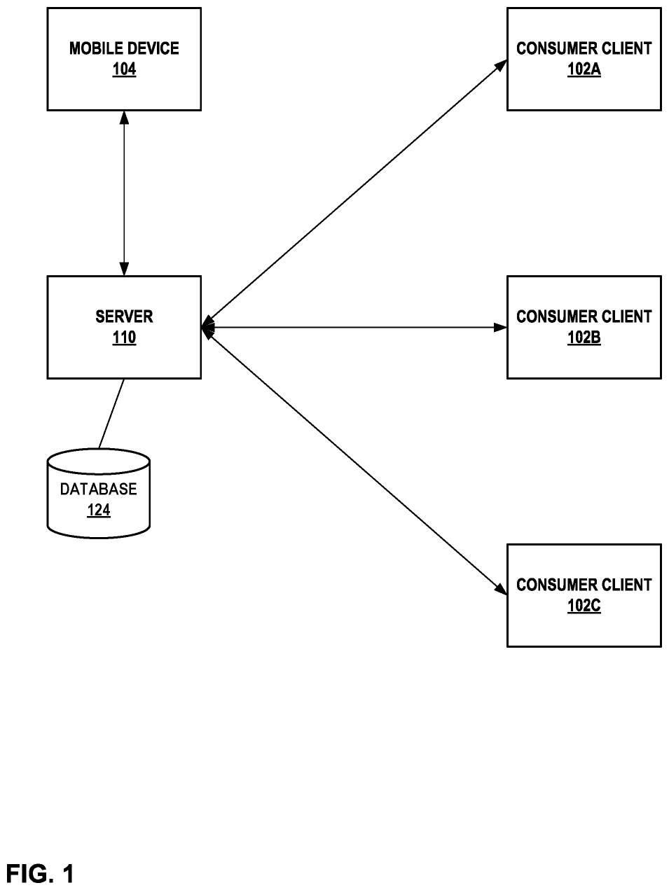

FIG. 1 is a block diagram illustrating an example environment that includes server device 110, with server device 110 being configured to perform the techniques described herein. Server device 110 may include an application programming interface (API) which communicates with both database 124, either stored locally on server device 110, or on another server device or storage device not pictured, and one or more of mobile device 104 or consumer clients 102A-102C. Server device 110 may be configured to access database 124, which includes items previously purchased by various user accounts, and calculate individualized exchange prices for each user account if that user account were to exchange a previously purchased item, either for account credit or for a discount in a new purchase.

In some instances, server device 110 may host the ecommerce website on which the user account may purchase items and exchange those purchased items for credit or when making additional purchases. As such, server device 110 may communicate directly with mobile device 104 to send communications back and forth between server device 110 and mobile device. Those communications may include outputting user interfaces for the ecommerce website hosted by server device 110, receiving indications of desired transactions from mobile device 104 at server device 110, accessing database 124 that includes previous purchases made by the user account, and calculating exchange prices for those items that will be output for display on mobile device 104.

In other instances, server device 110 may simply host the API used by one or more of consumer clients 102A-102C. In such instances, users may access an ecommerce website or API hosted by one or more of consumer clients 102A-102C. Consumer clients 102A-102C may access server device 110 to keep track of items previously purchased by the various users in database 124, and may further access server device 110 to calculate individualized exchange prices for those users within the environment hosted by consumer clients 102A-102C. As such, in these instances, server device 110 may not itself host any ecommerce website, but rather may provide the platform in which exchanges can be made in accordance with one or more techniques described herein.

In the instances where server device 110 hosts the API provided to consumer clients 102A-102C, server device 110 may either provide a universal API to all of consumer clients 102A-102C or may provide individual APIs to subsets of consumer clients 102A-102C. For example, a user may purchase an item via consumer client 102A. Server device 110 may store an indication of that purchase in database 124, particular for the purchase on consumer client 102A. In instances where server device 110 provides an individual API to consumer client 102A, when a user makes a subsequent purchase through consumer client 102A or when the user wishes to get an account credit, server device 110 may provide consumer client 102A with an indication of that previously purchased item and an exchange price for swapping that previously purchased item. However, if that same user were to access consumer clients 102B or 102C, server device 110 may not provide the previously purchased item from consumer client 102A in a swap interface on consumer clients 102B or 102C.

In instances where server device 110 provides a universal API accessible by multiple of consumer clients 102A-102C, a user may still purchase an item via consumer client 102A. Server device 110 may store an indication of that purchase in database 124. If the user then wished to make a purchase on consumer client 102B, or wished to obtain a credit for consumer client 102B, consumer client 102B may contact server device 110 to determine whether the user had made any purchases on any of consumer clients 102A-102C in the past. Server device 110 may retrieve the previous purchase on consumer client 102A from database 124, calculate an exchange price for the items in that purchase, and provide those exchange prices to consumer client 102B.

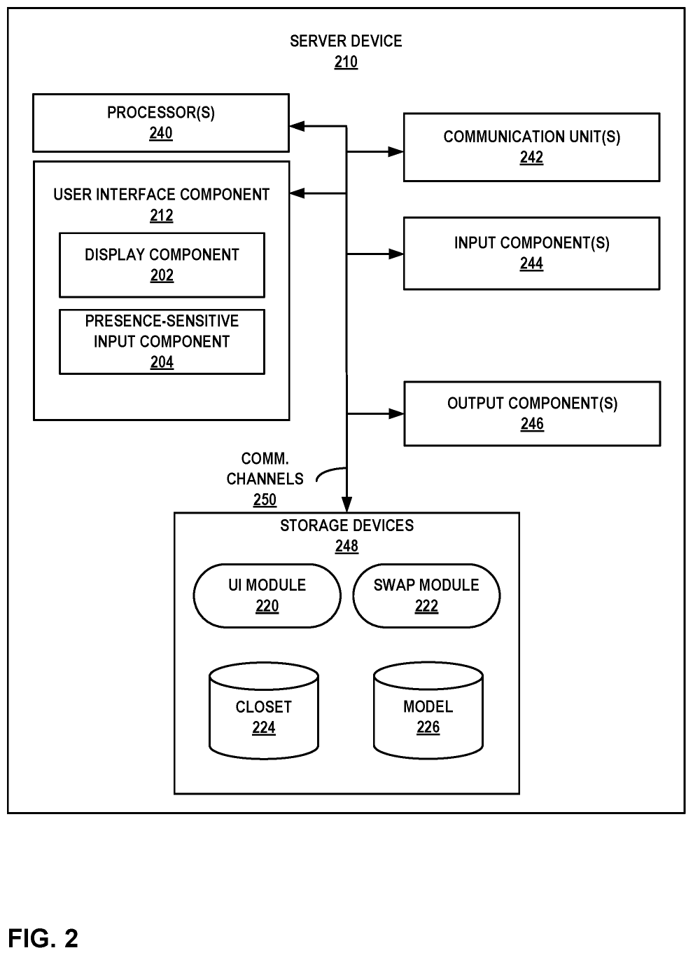

In this way, server device 110 may perform the techniques of storing previous purchases and calculating exchange prices for previous purchases on ecommerce websites hosted by server device 110, by individual ones of consumer clients 102A-102C, or universally across multiple of consumer clients 102A-102C using a novel API and database combination, as described herein. A more detailed description of this process is described below with respect to FIG. 2.

FIG. 2 is a block diagram illustrating an example computing device configured to perform the techniques described herein. Server device 210 of FIG. 2 is described below as an example of server device 110 of FIG. 1. FIG. 2 illustrates only one particular example of server device 210, and many other examples of server device 210 may be used in other instances and may include a subset of the components included in example server device 210 or may include additional components not shown in FIG. 2.

As shown in the example of FIG. 2, server device 210 includes user interface device (UID) 212, one or more processors 240, one or more communication units 242, one or more input components 244, one or more output components 246, and one or more storage components 248. UID 212 includes display component 202 and presence-sensitive input component 204. Storage components 248 of server device 210 include UI module 220, swap module 222, closet database 224, and model 226.

One or more processors 240 may implement functionality and/or execute instructions associated with server device 210 to dynamically price an item in closet database 224 for an exchange process. That is, processors 240 may implement functionality and/or execute instructions associated with server device 210 to dynamically determine an exchange price for an item in closet database 224, using model 226.

Examples of processors 240 include application processors, display controllers, auxiliary processors, one or more sensor hubs, and any other hardware configure to function as a processor, a processing unit, or a processing device. Modules 220 and 222 may be operable by processors 240 to perform various actions, operations, or functions of server device 210. For example, processors 240 of server device 210 may retrieve and execute instructions stored by storage components 248 that cause processors 240 to perform the operations described with respect to modules 220 and 222. The instructions, when executed by processors 240, may cause server device 210 to dynamically determine an exchange price for an item in closet database 224, using model 226

UI module 220 may similar operations for managing a user interface that server device 210 provides at various user interfaces, for facilitating interactions between a user of a client device and server device 210. For example, UI module 220 of server device 210 may include instructions for outputting (e.g., displaying) interface elements during a transaction process.

In some examples, swap module 222 may execute locally (e.g., at processors 240) to provide functions associated with dynamically determine an exchange price for an item in closet database 224, using model 226. In some examples, swap module 222 may act as an interface to a remote service accessible to server device 210. For example, swap module 222 may be an interface or application programming interface (API) to a remote server that dynamically determines an exchange price for an item in closet database 224, using model 226.

One or more storage components 248 within server device 210 may store information for processing during operation of server device 210 (e.g., server device 210 may store data accessed by modules 220 and 222, closet database 224, and model 226 during execution at server device 210). In some examples, storage component 248 is a temporary memory, meaning that a primary purpose of storage component 248 is not long-term storage. Storage components 248 on server device 210 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

Storage components 248, in some examples, also include one or more computer-readable storage media. Storage components 248 in some examples include one or more non-transitory computer-readable storage mediums. Storage components 248 may be configured to store larger amounts of information than typically stored by volatile memory. Storage components 248 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Storage components 248 may store program instructions and/or information (e.g., data) associated with modules 220 and 222, closet database 224, and model 226. Storage components 248 may include a memory configured to store data or other information associated with modules 220 and 222, closet database 224, and model 226.

Storage components 248 may also be configured to operate using blockchains. For instance, closet database 224 may store transaction information for customers, including current products expected to be owned by customers through previous purchases and exchanges in a marketplace associated with server device 210. A copy of this ledger may be stored in storage components 248, with closet database 224 and all of the transaction/product information in closet database 224 being stored both locally and distributed throughout a larger system. As additional transactions are made through server device 210, storage components 248 may update this ledger to provide an immutable, secure, and current record of products purchased by each user.

A blockchain is a series of blocks that are linked to one another using cryptography, such as a hash function. Each block of the blockchain includes a hashed version of the previous block of the blockchain, a timestamp of the update to the blockchain, the new information for the blockchain, and, potentially, additional information about the transaction adding the new information, such as a user identification or some other sort of metadata. The initial instance of a new transaction is issued from some node in the system and to another node in the system. If the issuer node is connected to each other node in the system, the issuer node may distribute the update to each other node in the system, enabling every node in the system to maintain an immutable, up-to-date version of the blockchain upon the blockchain being updated. In other instances, such as where the issuer node is not connected to other nodes in the system, a peer-to-peer network may be utilized to distribute the blocks throughout the nodes participating in the blockchain storage system. By including a hashed version of the previous block and a timestamp for each transaction in each block of the blockchain, nodes in the peer-to-peer network need not explicitly receive each block in the system, but may always ensure the node is storing the most up-to-date version of the blockchain possible through comparison of the timestamp in the most recent block stored on the node to a timestamp in the most recent block stored on another node in the peer-to-peer network.

Furthermore, each node may individually verify that any updates to the blockchain are valid using the hashed version of the previous block that must be included in any transaction to the blockchain. For instance, if a node determines that the hashed portion of a new transaction does, in fact, include the most recent block of the blockchain stored in the node, then the node may approve the transaction as a valid transaction. Conversely, if the node determines that the hashed portion of the new transaction does not include the most recent block of the blockchain stored in the node, then the node may determine the transaction is invalid. Furthermore, since each block includes a hash of the previous block, a most recent block of the blockchain would include, in order, a history of every valid transaction in the blockchain. As such, if the node determines that various details of the history of blocks hashed into the most recent block is incorrect, the node may determine that the new transaction is invalid. Furthermore, if the node determines that the timestamp information for the new block is incompatible with the most recent block in the blockchain, such as if the timestamp in the transaction is before a timestamp of the most recent block in the blockchain stored on the node, the node will determine that the transaction is invalid.

In this manner, blockchain provides a reliable, immutable system to maintain updated records of what the issuer node has deemed to be current transaction information for users associated with closet database 224. By enabling an issuer node to push updates to nodes of a peer-to-peer network via blockchain transactions, server device 210 may distribute storage responsibility for closet database 224, making server device 210 execute more efficiently.

Communication channels 250 may interconnect each of the components 212, 240, 242, 244, 246, and 248 for inter-component communications (physically, communicatively, and/or operatively). In some examples, communication channels 250 may include a system bus, a network connection, an inter-process communication data structure, or any other method for communicating data.

One or more communication units 242 of server device 210 may communicate with external devices via one or more wired and/or wireless networks by transmitting and/or receiving network signals on one or more networks. Examples of communication units 242 include a network interface card (e.g. such as an Ethernet card), an optical transceiver, a radio frequency transceiver, a GPS receiver, or any other type of device that can send and/or receive information. Other examples of communication units 242 may include short wave radios, cellular data radios, wireless network radios, as well as universal serial bus (USB) controllers.

One or more input components 244 of server device 210 may receive input. Examples of input are tactile, audio, and video input. Input components 244 of server device 210, in one example, includes a presence-sensitive input device (e.g., a touch sensitive screen, a PSD), mouse, keyboard, voice responsive system, camera, microphone or any other type of device for detecting input from a human or machine. In some examples, input components 244 may include one or more sensor components 252 one or more location sensors (GPS components, Wi-Fi components, cellular components), one or more temperature sensors, one or more movement sensors (e.g., accelerometers, gyros), one or more pressure sensors (e.g., barometer), one or more ambient light sensors, and one or more other sensors (e.g., infrared proximity sensor, hygrometer sensor, and the like). Other sensors, to name a few other non-limiting examples, may include a heart rate sensor, magnetometer, glucose sensor, olfactory sensor, compass sensor, or a step counter sensor.

One or more output components 246 of server device 210 may generate output in a selected modality. Examples of modalities may include a tactile notification, audible notification, visual notification, machine generated voice notification, or other modalities. Output components 246 of server device 210, in one example, includes a presence-sensitive display, a sound card, a video graphics adapter card, a speaker, a cathode ray tube (CRT) monitor, a liquid crystal display (LCD), a light emitting diode (LED) display, an organic LED (OLED) display, a virtual/augmented/extended reality (VR/AR/XR) system, a three-dimensional display, or any other type of device for generating output to a human or machine in a selected modality.

UID 212 of server device 210 may include display component 202 and presence-sensitive input component 204. Display component 202 may be a screen, such as any of the displays or systems described with respect to output components 246, at which information (e.g., a visual indication) is displayed by UID 212 while presence-sensitive input component 204 may detect an object at and/or near display component 202.

While illustrated as an internal component of server device 210, UID 212 may also represent an external component that shares a data path with server device 210 for transmitting and/or receiving input and output. For instance, in one example, UID 212 represents a built-in component of server device 210 located within and physically connected to the external packaging of server device 210 (e.g., a screen on a mobile phone). In another example, UID 212 represents an external component of server device 210 located outside and physically separated from the packaging or housing of server device 210 (e.g., a monitor, a projector, etc. that shares a wired and/or wireless data path with server device 210).

UID 212 of server device 210 may detect two-dimensional and/or three-dimensional gestures as input from a user of server device 210. For instance, a sensor of UID 212 may detect a user's movement (e.g., moving a hand, an arm, a pen, a stylus, a tactile object, etc.) within a threshold distance of the sensor of UID 212. UID 212 may determine a two or three-dimensional vector representation of the movement and correlate the vector representation to a gesture input (e.g., a hand-wave, a pinch, a clap, a pen stroke, etc.) that has multiple dimensions. In other words, UID 212 can detect a multi-dimension gesture without requiring the user to gesture at or near a screen or surface at which UID 212 outputs information for display. Instead, UID 212 can detect a multi-dimensional gesture performed at or near a sensor which may or may not be located near the screen or surface at which UID 212 outputs information for display.

In accordance with one or more techniques of the current disclosure, UI module 220 may receive an indication of a first transaction to purchase a first set of one or more items by a user account. UI module 220 may receive the first transaction at a first time. The one or more items each could be one or more articles of clothing, but the techniques described herein may be utilized in other marketplaces, such as electronics, household items, video games, household linens (e.g., towels or sheets), or any other product that could reasonably be re-sold, recycled, or upcycled.

Swap module 222 may store a purchased indication for each of the one or more items in the first set in a purchase history database (also referred to herein as “closet database 224) for the user account. Rather than simply track past purchases, however, closet database 224 may be a dynamically updating database that keeps track of current products that the user owns, including the ability to remove products from closet database 224 if they are exchanged, swapped, or donated. For instance, the user may remove items themselves by sending requests to server device 210 to remove certain items from closet database 224, or swap module 222 may automatically remove an item from closet database 224 once the user has indicated it is to be exchanged at an entity associated with server device 210. In this way, as opposed to a simple purchase history, swap module 222 maintains closet database 224 as a current reflection of items owned by the user that were purchased through this interface.

At a second time later than the first time, UI module 220 may receive an indication of a process initiating for a second transaction. This second transaction could either be a subsequent purchase of new items or a give-back transaction to obtain credit for the user account. UI module 220 may also receive, as part of the process for the second transaction, a request to exchange a first item of the first set of one or more items from closet database 224. In other words, the user may wish to obtain credit for their account, which may be put towards a subsequent purchase, by returning a previously purchased and used item such that the used item can be recycled or upcycled.

Swap module 222 may calculate an exchange price for the first item, either before the request for the exchange is received or after receiving the request to exchange the first item. Swap module 222 may calculate the exchange price for the first item, and any item in the plurality of items in closet database 224, using model 226, which may be based on one or more past exchanges by the user account. Model 226 may also be based on any number of other inputs or histories, including one or more of a color of the respective item, a brand of the respective item, a fabrication of the respective item, a resale value of the respective item, a size of the respective item, a recycling rating of the respective item, a seasonality relevance score for the respective item, a frequency that the user account exchanges items, a type of items previously exchanged by the user account, a quality of the respective items previously exchanged by the user account, a length of ownership for the respective item, a customer status for the user account, and a quality of the respective item. Model 226 may also be different for each user account, meaning that, for a same item, the exchange price may be a user-specific exchange price for the particular user account, and model 226 may be a unique, user-specific model for the particular user account.

Closet database 224 may include a plurality of items that were previously purchased by the user account, including the first set of one or more items from the first transaction. For each item of the plurality of items, swap module 222 may calculate an exchange value for the respective item based on one or more characteristics of the respective item. The one or more characteristics of the respective item could include one or more of an age of the respective item, a fabrication of the respective item, a manufacturer's quality of the respective item, one or more materials used to make the respective item, a size of the respective item, a brand of the item, an original price of the respective item, a type of clothing that is the respective item, an amount of time that has passed between a current time and a time at which the respective item was purchased, or any other input that may be fed into model 226. Swap module 222 may then calculate a final exchange price for each of the plurality of items, including the first item, based on the exchange value for the respective item and model 226 trained using past exchanges for the user account.

In response to UI module 220 receiving the indication of the process initiating for the second transaction being a purchase of the second set of one or more items by the user account, UI module 220 may output, for display on a user computing device (e.g., mobile device 104 of FIG. 1 or a device accessing one of consumer clients 102A-102C), a user interface that includes a graphical indication for each of one or more items of the plurality of items, including the first item, in closet database 224. The graphical indication may include at least a description of the respective item (e.g., a textual description or an image of the item) and the exchange price for the respective item as calculated using model 226. UI module 220 may then receive a selection of the first item prior to swap module 222 applying any account credits.

In some instances, each of the plurality of items in closet database 224 are items having a same brand or items offered on a same Internet marketplace (e.g., from a same ecommerce website). In other instances, at least the first item of the plurality of items and a second item of the plurality of items are items having a different brand or items offered on different, exclusive Internet marketplaces (e.g., from different ecommerce websites). In other words, closet database 224 may be an aggregation of items purchased by a same user across different websites that have entered an agreement (or are owned by the same corporate entity) to allow exchanges and credits to be applied across the different websites. In such examples, the first item may be a first brand sold on a first Internet marketplace, wherein the second item may be a second brand sold on a second Internet marketplace, with the first Internet marketplace and the second Internet marketplace being different Internet marketplaces. Swap module 222 may provide a common application programming interface (API) across for both the first Internet marketplace and the second Internet marketplace to allow an exchange of the first item on the second Internet marketplace and to allow an exchange of the second item on the first Internet marketplace.

Swap module 222 may apply a credit equal to the exchange price to the user account. If the second transaction includes a purchase of a second set of one or more items by the user account, then swap module 222 may apply the credit to the user account by applying a discount to a purchase price for the second purchase, with the discount being equal to the credit for the first item. In other instances, swap module 222 may instead store the credit in closet database 224 for later use. At a third time later than the second time, UI module 220 may receive an indication of a process initiating for a third transaction of a purchase of a second set of one or more items by the user account. Swap module 222 may apply the credit for the user account to a purchase price of the third transaction.

After the credit is given or applied to the purchase, server device 210 may ensure that the quality of the received product, or the receipt of the product in the first place, is satisfactory for the ultimate credit given. As part of the exchange process, the entity associated with server device 210 may physically receive the first item after completion of the second transaction. The first item may be evaluated for quality, and the quality of the item may be input into server device 210. Swap module 222 may adjust any credits given to the user account based on the actual item received, and may also update model 226 based on the quality of the first item.

Swap module 222 may also update the credit and model 226 based on a comparison of the expected quality of the item and an actual quality of the item. For instance, swap module 222 may receive an estimated quality of the first item during the process of the second transaction. Swap module 222 may calculate the exchange price using model 226 and the estimated quality of the first item. The entity associated with server device 210 may physically receive the first item, as part of an exchange process, after completion of the second transaction and evaluate an actual quality of the first item. Swap module 222 may compare the actual quality of the first item to the estimated quality to determine a quality difference between the actual quality and the estimated quality, and update model 226 based on the quality difference between the actual quality and the estimated quality for the first item. For instance, swap module 222 may decrease one or more weights for future exchange prices and model 226 when the actual quality is less than the estimated quality, increase the one or more weights for future exchange prices and model 226 when the actual quality is greater than the estimated quality, and/or slightly increase the one or more weights for future exchange prices and model 226 when the actual quality is equal to the estimated quality (such that future exchanges are encouraged). Swap module 222 may also update the exchange price based on the quality difference between the actual quality and the estimated quality for the first item, either charging the user an additional amount if the swap was made as part of a purchase or crediting the user additional credit if the quality of the received item was better than initially indicated.

In some instances, upon purchasing the initial set of one or more items, swap module 222 may calculate an exchange price for each of the one or more items. In these examples, the exchange price for each of the one or more items may be initially calculated before UI module 220 receives an indication of a process initiating for an exchange of one of the one or more items. Ultimately, it should be recognized that swap module 222 may calculate the exchange price for any item previously purchased by a user account at any point after the purchase has been made in accordance with the techniques described herein. For the purposes of this disclosure, it is merely recognized that a user account may exchange a previously purchased item for a price calculated by swap module 222 based on characteristics known of the item or characteristics known of the user account at the time of exchange price calculation, whether that time is immediately after purchase, at some time after the user purchased the item, during a transaction where the user wishes to exchange the item, or during a transaction where the user is purchasing another item.

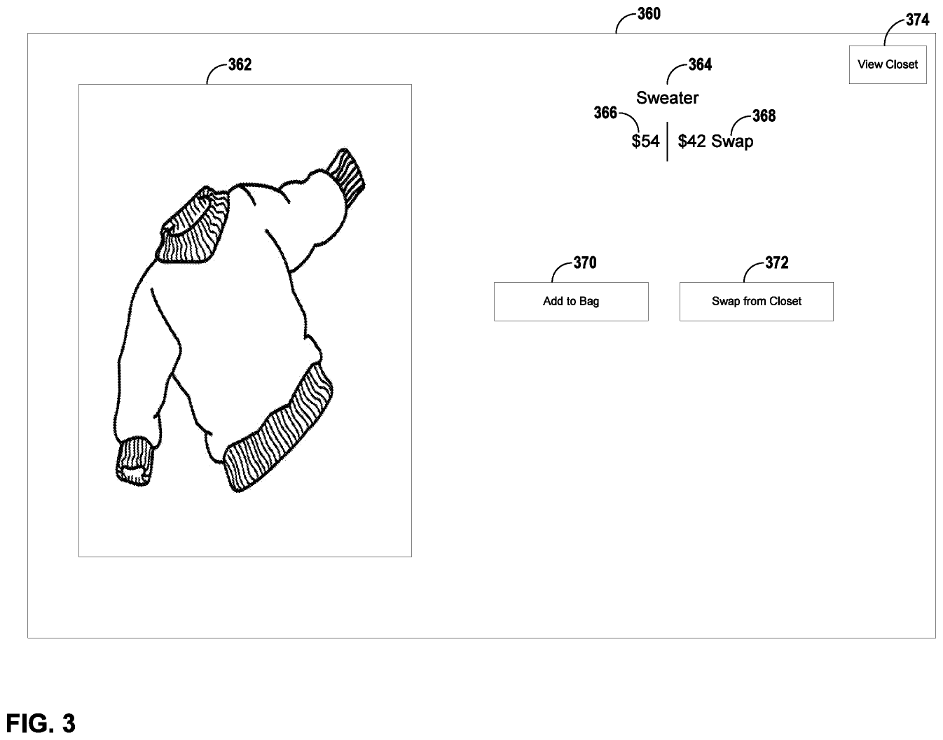

FIG. 3 is a conceptual diagram illustrating an example graphical user interface (GUI) 360 in accordance with one or more of the techniques described herein. In GUI 360, item 362, with description 364, is shown on an ecommerce website, where item 362 is available for purchase. A user accessing the ecommerce website may purchase item 362 directly for price 366. If user selects the “Add to Bag” button 370, the ecommerce website may progress as a typical ecommerce website would, allowing the user the purchase item 362 for price 366.

Also shown is discounted price 368. In accordance with the techniques described herein, a server device (e.g., server device 210) may access a database of previously purchased items for the user account of the user making the purchase and calculate discounted price 368 as if the user were to exchange one of their previously purchased items. Discounted price 368 may be a generic price for if the user swaps any item they previously purchased, a maximum discounted price if the user swapped the highest priced item from their previously purchased set of items, a minimum discounted price if the user swapped the lowest priced item from their previously purchased set of items, or some other discounted price possible from the exchange of one or more items from their previously purchased set of items. An additional “Swap from Closet” button 372 is also shown. If the user selects button 372, the user may be taken to a different checkout page where the user can select one or more items from their previously purchased set of items to exchange for a discounted price for item 362.

In other examples, however, the user may have the choice to exchange items from their previously purchased set of items by selecting button 370, and button 372 may not be present. In other words, while price 366 and discounted price 368 may both be shown in GUI 360, but the user may not have to make a decision regarding exchanging an item from a previously purchased set of items until after selecting button 370 and the user is taken to a different page on the ecommerce website.

GUI 360 may also include “View Closet” button 374. If the user wishes to simply exchange items that they already own for credit, receiving a selection of button 374 may navigate to a webpage where the user can do so.

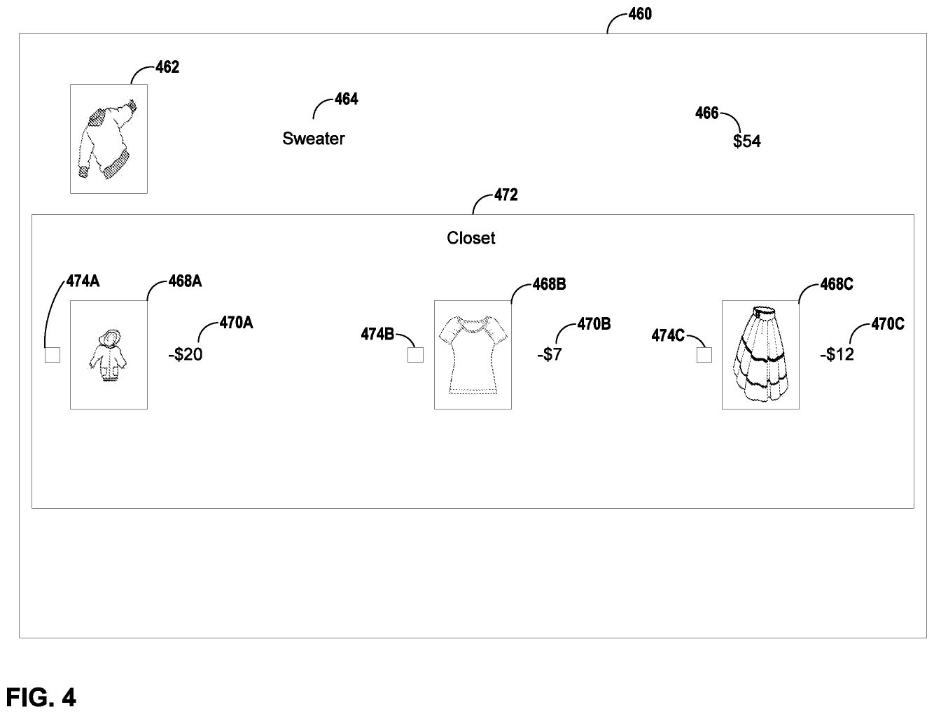

FIG. 4 is a conceptual diagram illustrating an example graphical user interface (GUI) 460 in accordance with one or more of the techniques described herein. GUI 460 may be associated with a webpage shown after user has added item 362 (now shown as item 462) to their online shopping cart. In some instances, the user selected button 372 to explicitly request a “Swap from Closet” action to take place on the server device. In other instances, the user may have selected button 370 to simply add item 362 to their online shopping cart and the server may offer the swapping process during the normal course of checkout.

Item 462 is shown in GUI 460 with description 464 and original price 466. Also shown in GUI 460 is a graphical representation of the items previously purchased by the user account making the instant purchase. These previously purchased items 468A-468C each have respective exchange prices 470A-470C and selection boxes 474A-474C. Exchange prices 470A-470C may be calculated in accordance with the description in FIG. 2 and elsewhere in this disclosure. A selection of any one or more of selection boxes 474A-474C may apply a discount to original price 466 equal to the exchange price 470A-470C associated with the selected one or more of selection boxes 474A-474C. For instance, if the user selects selection box 474A, the server may apply a discount equal to exchange price 470A to original price 466, decreasing original price 466 to equal $34. If the user additionally selects selection box 474C, exchange price 470C may be applied as an additional discount, further decreasing original price 466 to equal $22.

In exchange for this discount, an entity associated with the server hosting the ecommerce website associated with GUI 460 may expect to receive a shipment that includes items 468A and 468C within a certain amount of time of the user making the purchase. For example, the entity may send a return envelope, bag, or box with the shipment of item 462 that the user may utilize to ship items 468A and 468C back to the entity. The user may also provide their own packaging to ship items 468A and 468C back to the entity. Once received, the server may remove items 468A and 468C from future instances of closet 472, replacing items 468A or 468C with an indication of item 462 and a newly calculated exchange price for item 462.

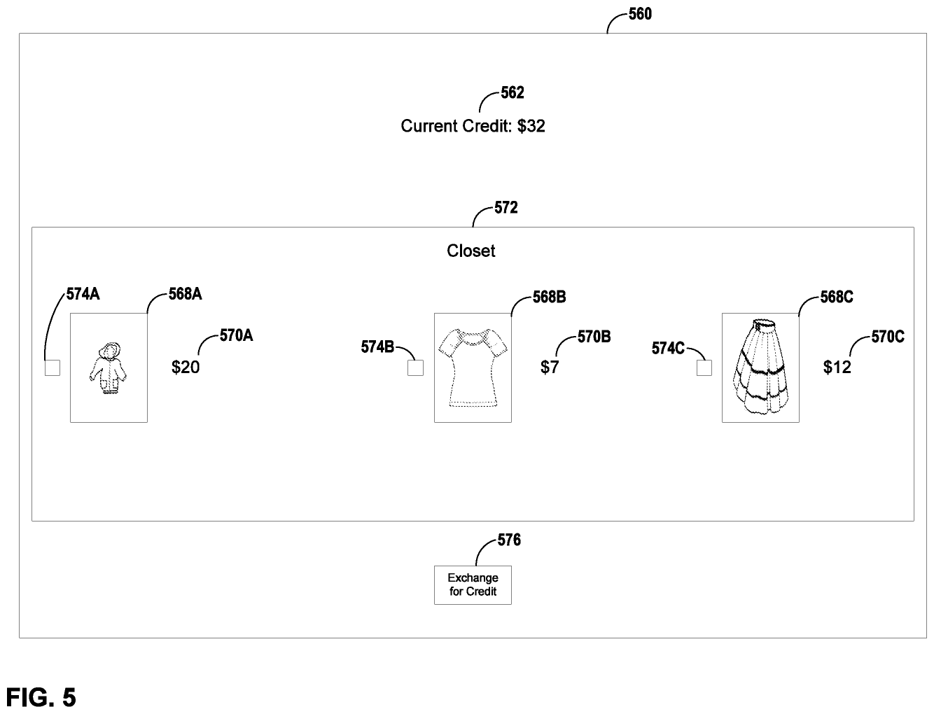

FIG. 5 is a conceptual diagram illustrating an example graphical user interface (GUI) 560 in accordance with one or more of the techniques described herein. GUI 560 may be associated with a webpage shown after user has added selected “View Closet” button 374 from GUI 360.

Shown in GUI 560 is an indication of the current amount of credits 562 for the particular user account, obtained from having previously exchanged purchased items for credit. Also shown in GUI 560 is a graphical representation of the items previously purchased by the user account making the instant transaction in closet 572. These previously purchased items 568A-568C each have respective exchange prices 570A-570C and selection boxes 574A-574C. Exchange prices 570A-570C may be calculated in accordance with the description in FIG. 2 and elsewhere in this disclosure, either after those items were purchased, upon accessing the closet, or when a transaction is occurring given the known characteristics of the item and the user account at the time of calculation. A selection of any one or more of selection boxes 574A-574C may apply an additional credit to be added to the current amount of credits 562 equal to the exchange price 570A-570C associated with the selected one or more of selection boxes 574A-574C. For instance, if the user selects selection box 574B, the server may apply a $7 credit (equal to exchange price 570B) to the credits 562 already owned by the user account. To complete the exchange, the user may select “Exchange for Credit” button 576.

In exchange for these credits, an entity associated with the server hosting the ecommerce website associated with GUI 460 may expect to receive a shipment that includes item 568B within a certain amount of time of the user making the transaction. For example, the entity may send a return envelope, bag, or box to the user that the user may utilize to ship item 568B back to the entity. The user may also provide their own packaging to ship item 568B back to the entity. Once received, the server may remove item 568B from future instances of closet 572.

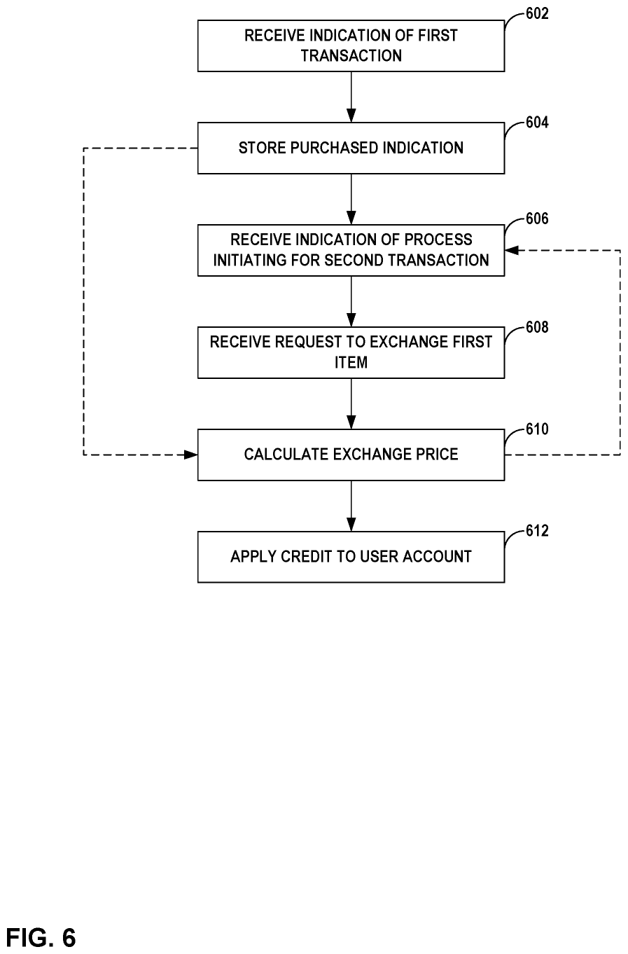

FIG. 6 is a flow diagram illustrating an example technique of the current disclosure. The techniques of FIG. 6 may be performed by one or more processors of a computing device, such as server device 110 of FIG. 1 and/or server device 210 illustrated in FIG. 2. For purposes of illustration only, the techniques of FIG. 6 are described within the context of server device 210 of FIG. 2, although computing devices having configurations different than that of server device 210 may perform the techniques of FIG. 6.

In accordance with this disclosure, UI module 220 may receive an indication of a first transaction to purchase a first set of one or more items by a user account (602), the first transaction occurring at a first time. Swap module 222 may store a purchased indication for each of the one or more items in the first set in a purchase history database (e.g., closet database 224) for the user account (604).

In some instances, upon purchasing the one or more items, swap module 222 may calculate an exchange price for each of the one or more items (610). In these examples, the exchange price for each of the one or more items may be initially calculated before UI module 220 receives an indication of a process initiating for an exchange of one of the one or more items. Ultimately, it should be recognized that swap module 222 may calculate the exchange price for any item previously purchased by a user account at any point after the purchase has been made in accordance with the techniques described herein. For the purposes of this disclosure, it is merely recognized that a user account may exchange a previously purchased item for a price calculated by swap module 222 based on characteristics known of the item or characteristics known of the user account at the time of exchange price calculation, whether that time is immediately after purchase, at some time after the user purchased the item, during a transaction where the user wishes to exchange the item, or during a transaction where the user is purchasing another item.

UI module 220 may receive an indication of a process initiating for a second transaction, the second transaction occurring at a second time later than the first time (606). UI module 220 may further receive, as part of the process for the second transaction, a request to exchange a first item of the first set of one or more items (608). Swap module 222 may calculate an exchange price for the first item (610). Swap module 222 may further apply a credit to the user account (612), wherein the credit is equal to the exchange price.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples of the disclosure have been described. Any combination of the described systems, operations, or functions is contemplated. These and other examples are within the scope of the following claims.

What is claimed is:

1. A method comprising:
receiving, by one or more processors of a server device, an indication of a first transaction to purchase a first set of one or more items by a user account, the first transaction occurring at a first time;
storing, by the one or more processors of the server device, a purchased indication for each of the one or more items in the first set in a purchase history database for the user account;
receiving, by the one or more processors of the server device, an indication of a process initiating for a second transaction, the second transaction occurring at a second time later than the first time;
receiving, by the one or more processors of the server device and as part of the process for the second transaction, a request to exchange a first item of the first set of one or more items;
calculating, by the one or more processors of the server device, an exchange price for the first item; and
applying, by the one or more processors of the server device, a credit to the user account, wherein the credit is equal to the exchange price.

2. The method of claim 1, wherein the second transaction comprises a purchase of a second set of one or more items by the user account, wherein applying the credit to the user account comprises:
applying, by the one or more processors of the server device, a discount to a purchase price for the second transaction, wherein the discount is equal to the exchange price for the first item.

3. The method of claim 1, further comprising:
receiving, by the one or more processors of the server device, an indication of a process initiating for a third transaction of a purchase of a second set of one or more items by the user account, the third transaction occurring at a third time later than the second time;
applying, by the one or more processors of the server device, the credit for the user account to a purchase price of the third transaction.

4. The method of claim 1, wherein calculating the exchange price for the first item comprises calculating, by the one or more processors of the server device, the exchange price for the first item using a model based on one or more past exchanges by the user account.

5. The method of claim 4, further comprising receiving, by the one or more processors and as one or more inputs to the model, one or more of:
a color of the first item,
a brand of the first item,
a fabrication of the first item,
a resale value of the first item,
a recycling rating of the first item,
a seasonality relevance score for the first item,
a frequency that the user account exchanges items,
a type of items previously exchanged by the user account,
a quality of the items previously exchanged by the user account,
a length of ownership for the first item,
a customer status for the user account, and
a quality of the first item.

6. The method of claim 4, further comprising:
physically receiving the first item, as part of an exchange process, after completion of the second transaction;
evaluating a quality of the first item; and
updating, by the one or more processors of the server device, the model based on the quality of the first item.

7. The method of claim 4, further comprising:
receiving, by the one or more processors of the server device, an estimated quality of the first item during the process of the second transaction;
calculating, by the one or more processors of the server device, the exchange price using the model and the estimated quality of the first item;
physically receiving the first item, as part of an exchange process, after completion of the second transaction;
evaluating an actual quality of the first item;
comparing the actual quality of the first item to the estimated quality to determine a quality difference between the actual quality and the estimated quality; and
updating, by the one or more processors of the server device, the model based on the quality difference between the actual quality and the estimated quality for the first item.

8. The method of claim 7, wherein updating the model comprises:
decreasing one or more weights for future exchange prices when the actual quality is less than the estimated quality;
increasing the one or more weights for future exchange prices when the actual quality is greater than the estimated quality; and
slightly increasing the one or more weights for future exchange prices when the actual quality is equal to the estimated quality.

9. The method of claim 4, wherein the exchange price comprises a user-specific exchange price for the user account, wherein the model comprises a user-specific model for the user account, and wherein the method further comprises:
updating, by the one or more processors of the server device, the exchange price based on the quality difference between the actual quality and the estimated quality for the first item.

10. The method of claim 1, wherein the purchase history database comprises a blockchain.

11. The method of claim 1, wherein the purchase history database comprises a plurality of items, wherein the plurality of items includes the first set of one or more items, and wherein the method further comprises:
for each item of the plurality of items, calculating, by the one or more processors of the server device, an exchange value for the respective item based on one or more characteristics of the respective item.

12. The method of claim 11, wherein the one or more characteristics of the respective item comprise one or more of:
an age of the respective item,
a manufacturer's quality of the respective item,
one or more materials used to make the respective item,
a size of the respective item,
a brand of the item,
an original price of the respective item,
a type of clothing that is the respective item, and
an amount of time that has passed between a current time and a time at which the respective item was purchased.

13. The method of claim 11, further comprising:
calculating, by the one or more processors of the server device, an exchange price for each of the plurality of items, including the first item, based on the exchange value for the respective item and a user-specific model trained using past exchanges for the user account.

14. The method of claim 11, further comprising:
in response to receiving the indication of the process initiating for the second transaction of the second set of one or more items by the user account, outputting, by the one or more processors of the server device and for display on a user computing device, a user interface that includes a graphical indication for each of one or more items of the plurality of items, including the first item, in the purchase history database, the graphical indication including at least a description of the respective item and the exchange price for the respective item; and
receiving, by the one or more processors of the server device, a selection of the first item.

15. The method of claim 11, wherein each of the plurality of items are items having a same brand or items offered on a same Internet marketplace.

16. The method of claim 11, wherein at least the first item of the plurality of items and a second item of the plurality of items are items having a different brand or items offered on different, exclusive Internet marketplaces.

17. The method of claim 16, wherein the first item comprises a first brand sold on a first Internet marketplace, wherein the second item comprises a second brand sold on a second Internet marketplace, wherein the first Internet marketplace and the second Internet marketplace comprise different Internet marketplaces, and wherein the method further comprises:
utilizing, by the one or more processors of the server device, a common application programming interface (API) across for both the first Internet marketplace and the second Internet marketplace to allow an exchange of the first item on the second Internet marketplace and to allow an exchange of the second item on the first Internet marketplace.

18. The method of claim 1, wherein the one or more items each comprise one or more articles of clothing.

19. A device comprising:
one or more communication units;
one or more storage components configured to store a purchase history database; and
one or more processors configured to:
receive an indication of a first transaction to purchase a first set of one or more items by a user account, the first transaction occurring at a first time;
store a purchased indication for each of the one or more items in the first set in the purchase history database for the user account;
receive an indication of a process initiating for a second transaction, the second transaction occurring at a second time later than the first time;
receive, as part of the process for the second purchase, a request to exchange a first item of the first set of one or more items;
calculate an exchange price for the first item; and
apply a credit to the user account, wherein the credit is equal to the exchange price.

20. A non-transitory computer-readable storage medium having stored thereon instructions that, when executed, cause one or more processors of a server device to:
receive an indication of a first transaction to purchase a first set of one or more items by a user account, the first transaction occurring at a first time;
store a purchased indication for each of the one or more items in the first set in a purchase history database for the user account;
receive an indication of a process initiating for a second transaction, the second transaction occurring at a second time later than the first time;
receive, as part of the process for the second purchase, a request to exchange a first item of the first set of one or more items;
calculate an exchange price for the first item; and
apply a credit to the user account, wherein the credit is equal to the exchange price.
